(19) United States
(12) Patent Application Publication
(10) Pub. No.: US 2002/0074522 A1
(43) Pub. Date: Jun. 20, 2002

(54) Scene projector apparatus

(76) Inventor: Eugene S. Zakar, Bethesda, MD (US)

Correspondence Address: ATTN: AMSRL-CS-CC-IP, U.S. ARMY Research Laboratory, 2800 Powder Mill Rd., Adelphi, MD, 20783-1197, US

(21) Appl. No.: 09/736,806

(22) Filed: Dec. 15, 2000

(51) Int. Cl. H01J 31/10

(52) U.S. Cl. 250/495.1

(57) ABSTRACT

An IR scene projector having an array of resistive elements which radiate a predetermined pattern of IR energy. A collimator in front of the array has a plurality of hollow chambers, each positioned in front of a resistive element. Each chamber has a reflective inner surface which directs any radiation from the resistive elements which impinges upon the surface to a more forwardly direction, thus increasing the intensity of the projected pattern.

### STATEMENT OF GOVERNMENT INTEREST

The invention described herein may be manufactured and used by or for the Government of the United States of America for government purposes without the payment of any royalties therefor.

### BACKGROUND OF THE INVENTION

In one class of scene projectors, an array of individually controlled pixel elements collectively project radiation in a certain pattern governed by a scene generation subsystem.

By way of example, various electro-optical and IR (infra red) image sensor systems, such as FLIR systems, must be tested prior to, and after deployment in the field. The testing process includes the projection of various simulated scenarios, in the form of thermal images, onto the IR detector portion of the sensor system in order to evaluate the response of the system.

The projection of these thermal images, such as dynamic targets and backgrounds, is accomplished by means of a thermal emitter comprised of an array of individual pixel elements, each operable to emit thermal radiation when energized. These pixel elements are closely spaced, thermally isolated resistive heaters. The resistive pixel elements exhibit a rapid response time, in the order of milliseconds, and may be positioned at a pitch distance of around 150 μm.

Often, the response of the system must be tested in the field, after initial deployment. Accordingly, IR scene projector systems, which are portable, must be designed for lightweight compact size, and low power consumption. Lower power, however, results in lower thermal pixel emission and intensity. The apparatus of the present invention can compensate for this loss of emission and intensity due to reduced power availability.

### SUMMARY OF THE INVENTION

Scene projector apparatus in accordance with the present invention includes an array of pixel elements, with each operable to emit radiation in a multi-directional pattern, including a forward direction. A collimator is positioned in front of the array and is comprised of an array of hollow chambers, each chamber being positioned in front of a respective pixel element. Each chamber has an inner surface which reflects any emitted radiation which impinges upon it, to a more forwardly direction. To increase reflectivity of the chamber surface, a reflective coating may be deposited thereon.

### BRIEF DESCRIPTION OF THE DRAWINGS

The invention will be better understood, and further objects, features and advantages thereof will become more apparent from the following description of the preferred embodiment, taken in conjunction with the accompanying drawings, in which:

FIG. 1 is a block diagram of typical scene projector apparatus.

FIG. 2 illustrates a portion of a pixel array of the prior art.

FIG. 2A is a view along line 2A-2A of FIG. 2.

FIG. 3 illustrates one embodiment of the present invention.

FIG. 3A is a view along line 3A-3A of FIG. 3.

FIG. 3B illustrates a wall of the collimator shown in FIG. 3.

FIGS. 4A to 4F illustrates the steps in the formation of the collimator shown in FIG. 3.

FIGS. 5 and 6 illustrate alternate forms of a collimator.

### DETAILED DESCRIPTION OF THE PREFERRED EMBODIMENTS

In the drawings, which are not necessarily to scale, like or corresponding parts are denoted by like or corresponding reference numerals.

The invention will be described, by way of example, with respect to an IR scene projector using a pixel array of resistive heaters, although it is to be understood that the invention is equally applicable to a variety of projectors, utilizing pixel arrays such as laser diodes, mirror membrane devices, deformable mirrors, electroluminescent elements, plasma discharge devices and CRTs, to name a few.

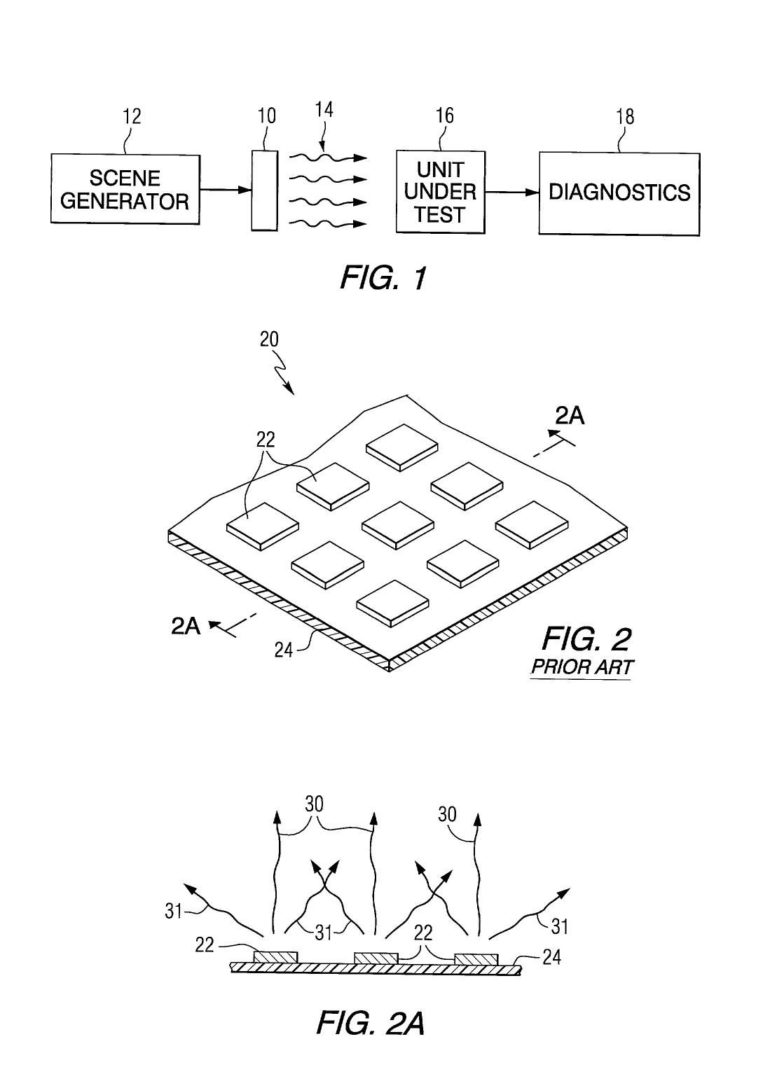

In FIG. 1 a flat panel display 10 is responsive to input signals from a scene generator 12 to project radiation indicative of the scene, as depicted by arrows 14. A unit to be tested, 16, is positioned to intercept the projected image and its response to various scenes is analyzed by a diagnostic system 18.

A typical projector is illustrated in FIG. 2 and is seen to include an array 20 (a portion of which is shown) of pixel elements 22 carried on a substrate member 24. A typical array 20 may include hundreds of thousands of such elements, which, for an IR projector would be comprised of individual resistive heaters. By way of example, each pixel element 22 may have a dimension of around 50 μm (microns) as the maximum length, if a rectangle, or a 50 μm diameter, if circular. The distance between pixels, that is, the pitch, may be on the order of 150 μm. Not illustrated in FIG. 2 are the conventional control lines for individually and selectively activating each element.

FIG. 2A is a view along line 2A-2A of FIG. 2 and illustrates the radiation pattern of the pixel elements, when energized. Radiation of IR energy is multi-directional as indicated by axially directed radiation, represented by arrows 30. In addition to this forwardly directed radiation, and as indicated by arrows 31, the radiation is also directed laterally, resulting in decreased intensity at the unit under test.

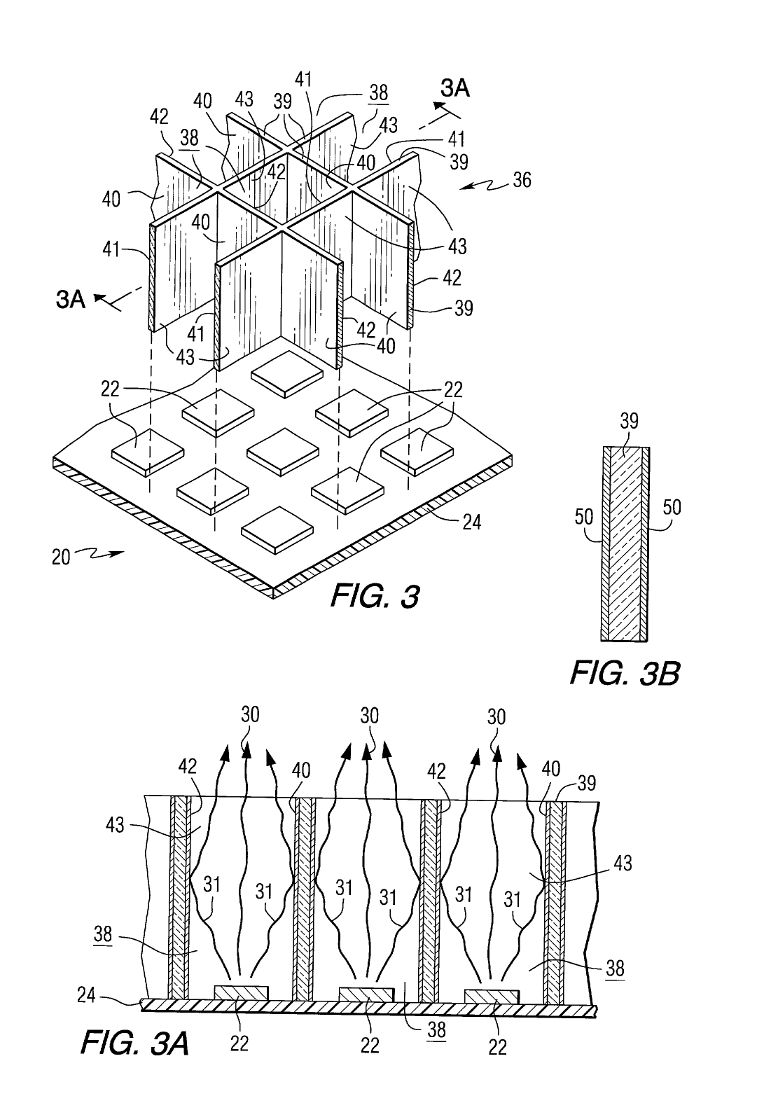

FIG. 3 illustrates one embodiment of the present invention. In addition to the pixel element array 20, the arrangement includes a collimator structure 36, disposed in front of the array 20 and may be spaced a short distance from the array 20, or may be bonded to the substrate 24. The collimator structure 36 includes a plurality of adjacent hollow chambers 38, with each chamber 38 being positioned over a respective pixel element 22, and each having an inner surface constructed and arranged to reflect any impinging radiation to a more forwardly direction. For the embodiment of FIG. 3, the chambers 38 are defined by a grid of walls 39, and it is seen that each chamber 38 is comprised of four wall portions 40, 41, 42 and 43.

More particularly, and with additional reference to FIG. 3A, off-axis radiation, as represented by arrows 31, instead of dissipating laterally, now is reflected from the walls of the chambers 38 and is projected in a more forward direction. Thus the unit under test, spaced from the array 20, will receive more of the generated energy allowing for a smaller-sized, lower-power portable assembly.

The collimator 36 itself may be made of a material which reflects the particular radiation generated by the pixel elements. Alternatively, and as indicated in FIG. 3B, a typical chamber wall 39 may have a reflective coating 50 deposited on the wall surface. For IR radiation the reflective coating 50 may be of a gold deposition, or any other metal or other material which reflects IR radiation.

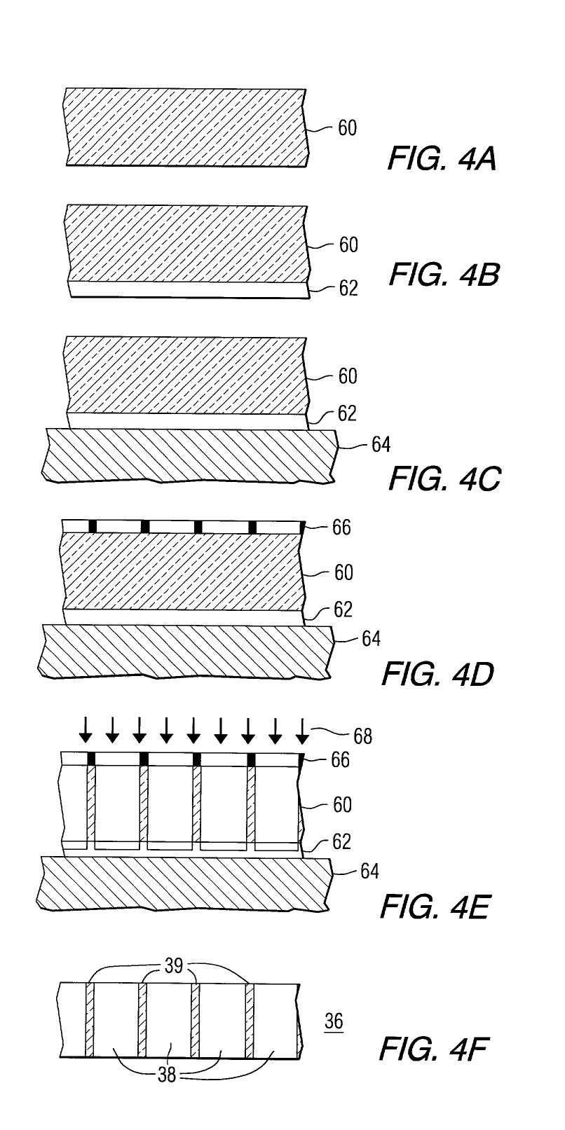

One method of constructing the collimator 36 is illustrated in FIGS. 4A to 4F. The starting material for the collimator structure is a wafer of silicon 60, illustrated in FIG. 4A. With a pixel size of 50 μm and a pixel pitch distance of 150 μm, the thickness of the wafer 60 may be in the order of 250 μm.

An oxide coating 62 is deposited upon the bottom of wafer 60, as seen in FIG. 4B, in order to protect the wafer holder 64, shown in FIG. 4C. A mask 66, having the desired grid pattern, to produce a chamber wall thickness of a few μm, or less, is deposited upon the surface of the wafer 60 to a depth of around 4.5 μm using conventional photolithography methods. Thereafter, the masked wafer is exposed to a deep reactive ion etching beam 68, as depicted in FIG. 4E. The deep reactive ion etching is preferably accomplished using a Deep Ion Reactive Etcher such as Plasma Therm DRIE model 770 system, the operation of which is described in U.S. Pat. No. 5,501,893.

As seen in FIG. 4E, the etching beam penetrates completely through the wafer 60 and into the sacrificial oxide coating 62. After the etching process, the mask 66 and oxide coating 62 are removed, resulting the collimator structure 36, having walls 39 defining chambers 38, illustrated in FIG. 4F.

Although four wall portions are shown by way of example, the chamber is not limited to this configuration. The chambers may have any desired shape pattern depending upon the aperture pattern of the mask 66, applied in FIG. 4D. Triangles, ovals or other shape chambers may be fabricated using the depicted process.

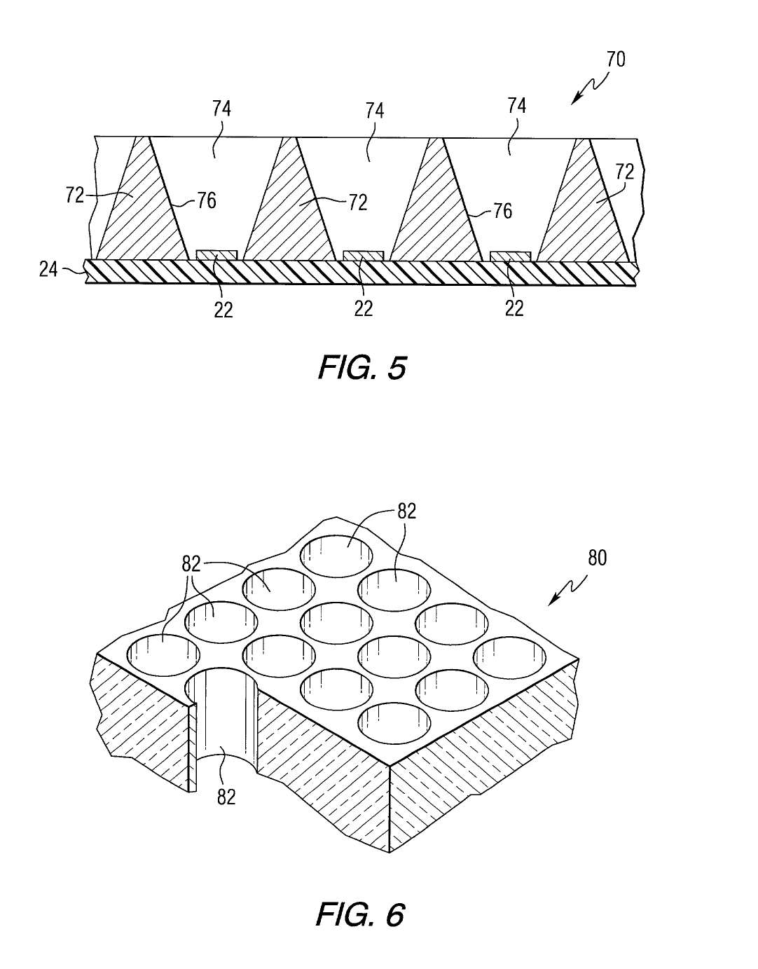

Another advantage of using the described process is that the angle and shape of the chamber wall surface may be changed by changing the process parameters such as power, pressures, gas chemistry mixture and cycle time. By way of example, and as illustrated in FIG. 5, a collimator 70, produced by the described process, has wall portions 72 defining a plurality of inverted conical chambers 74. The interior surface 76 of each chamber 74 is slanted so that emitted radiation from the pixel elements 22 is reflected to a generally forward direction, with the proper applied reflective coating.

A collimator structure may also be fabricated by other manufacturing methods. For example, FIG. 6 illustrates a collimator 80 having a plurality of adjacent chambers 82 produced by a laser drill. This process results in chambers 82 which are cylindrical, with each being positioned over a respective pixel element and with each having a reflective inner surface, as previously described.

It will be readily seen by one of ordinary skill in the art that the present invention fulfills all of the objects set forth herein. After reading the foregoing specification, one of ordinary skill in the art will be able to effect various changes, substitutions of equivalents and various other aspects of the present invention as broadly disclosed herein. It is therefore intended that the protection granted hereon be limited only by the definition contained in the appended claims and equivalents. Having thus shown and described what is at present considered to be the preferred embodiment of the present invention, it should be noted that the same has been made by way of illustration and not limitation. Accordingly, all modifications, alterations and changes coming within the spirit and scope of the present invention are herein meant to be included.

What is claimed is:

1. Scene projector apparatus, comprising:
an array of pixel elements;
each said pixel element being operable to emit radiation in a multi-directional pattern, including a forward direction;
a collimator positioned in front of said array of pixel elements;
said collimator having an array of hollow chambers, each said chamber being positioned in front of a respective one of said pixel elements of said array of pixel elements;
each said chamber having an inner surface of a material which will reflect any of said radiation, which impinges upon it, to a more forwardly direction.

2. Apparatus according to claim 1 wherein:
each said chamber has four walls.

3. Apparatus according to claim 2 wherein:
each said chamber is rectangular.

4. Apparatus according to claim 1 wherein:
each said chamber is cylindrical.

5. Apparatus according to claim 1 wherein:
each said chamber is conical.

6. Apparatus according to claim 1 wherein:
said inner surface of each said chamber includes a deposited reflective coating.

7. Apparatus according to claim 6 wherein:
said radiation is in the infrared range; and
said reflective coating is gold.

8. Apparatus according to claim 1 wherein:
said collimator is of a silicon material.

9. Apparatus according to claim 2 wherein:
the maximum dimension of a said pixel element is around 50 μm;
the pitch distance between said pixel elements is around 150 μm;
the thickness of a said wall is less than a few μm; and
the thickness of said collimator is around 250 μm.
